(19) United States
(12) Patent Application Publication
(10) Pub. No.: US 2022/0169866 A1
(43) Pub. Date: Jun. 2, 2022

(54) Thermally Conductive Thermoplastics for Selective Laser Sintering

(71) Applicant: Eaton Intelligent Power Limited, Dublin (IE)

(72) Inventors: Shahab Zekriardehani, Farmington Hills, MI (US); Jeremy M. Santiago Baerga, Southfield, MI (US); Javed Abdurrazzaq Mapkar, Northville, MI (US); John Trublowski, Troy, MI (US)

(73) Assignee: Eaton Intelligent Power Limited, Dublin (IE)

(21) Appl. No.: 17/538,341

(22) Filed: Nov. 30, 2021

Related U.S. Application Data
(60) Provisional application No. 63/119,254, filed on Nov. 30, 2020.

(51) Int. Cl. C09D 5/03; C09K 5/14; C09D 177/06; C09D 177/02; C09D 181/02; C09D 161/00; C09D 123/00; B33Y 70/00

(52) U.S. Cl. CPC C09D 5/031; C09K 5/14; C09D 177/06; C09D 177/02; B29C 64/153; C09D 161/00; C09D 123/00; B33Y 70/00; C09D 181/02

(57) ABSTRACT

The present disclosure relates to selective laser sintering printing and thermally conductive polymers used therein. Also described are processes for forming an article using selective laser sintering techniques.

### CROSS-REFERENCE TO RELATED APPLICATION

This application claims priority to U.S. Provisional Patent Application Ser. No. 63/119,254, filed Nov. 30, 2020, and which is hereby incorporated by reference in its entirety.

### STATEMENT REGARDING FEDERALLY SPONSORED RESEARCH OR DEVELOPMENT

This invention was made with government support under Government Contract DE-EE008722. The government has certain rights in the invention.

### FIELD OF THE DISCLOSURE

The present disclosure relates to selective laser sintering and thermally conductive polymers used therein.

### BACKGROUND

Polymers are insulative materials in nature with a thermal conductivity of less than 0.5 W/m/K. One approach to increase the thermal conductivity is the inclusion of conductive fillers including carbon fiber, graphite, boron nitride, alumina, gold, copper, and graphene into the polymer matrix which, in some cases, can result in an increase of thermal conductivity up to 55 W/m/K. Usually, a high concentration of conductive fillers is required in order to significantly increase the base thermal conductivity of a polymer.

Selective laser sintering is a popular polymer 3D printing method due to its fast yet high quality printing, excellent layer adhesion, and lack of support structure. Selective laser sintering (SLS) relies on sintering of material to form a solid mass. Sintering is the process of compacting a loose material (e.g., a plastic powder) by application of heat or pressure. Sintering does not melt the loose material. Instead, the sintering process provides a threshold amount of energy for the atoms of the separate particles in the powder to diffuse across the material boundaries.

In practice, SLS printers are guided by slicer software that separates 3D models into thin slices. By using the cross-sectional area of each slice, the slicer software directs the laser to hit the top layer of loose powder present in the material bin. The laser solidifies the powder according to the model being printed. Once solidified, the build platform moves down and a recoating blade applies a new layer of unsintered loose powder. This process repeats until all layers have been printed. The parts are then allowed to cool down inside of the powder bin.

Selective laser sintering, however, does not have a broad range of applications due to its limited number of available materials.

### SUMMARY OF THE DISCLOSURE

In one aspect, a process of forming an article generally comprises providing a thermally conductive polymer. The polymer has a particle size distribution of from about 10 μm to about 90 μm and is in the form of a loose powder. The process further comprises sintering the loose powder in a sintering process to produce a 3D printed article comprising the thermally conductive polymer. The sintering provides sufficient energy in order to solidify the powder.

In another aspect, a thermally conductive polymer generally comprises a polymer matrix and a thermally conductive filler in the polymer matrix. The polymer has a particle size distribution of from about 10 μm to about 90 μm and is in the form of a loose powder.

### DETAILED DESCRIPTION

One aspect of the present disclosure is directed to a thermally conductive polymer for use in selective laser sintering (SLS) techniques. Several macro- and nano-sized conductive fillers are selected and added into a polymer matrix to enhance the thermal conductivity of the polymer while maintaining thermal, rheological, and optical properties of the polymer. The size, type, geometry, and concentration of the fillers is selected in such a way so as to maximize the thermal conductivity of the polymer while keeping the average particle size and particle size distribution of the fillers within suitable ranges for successful SLS printing. Additionally, thermally conductive polymers for selective laser sintering printing of the present disclosure are configured such that the thermal properties (e.g., melting, crystallization, and heat capacity), rheological properties (e.g., surface tension and viscosity), and optical properties (e.g., reflection, adsorption, and transmission) are within suitable ranges for successful SLS printing.

The thermally conductive polymer used for SLS printing comprises a polymer matrix. In particular, useful polymers include thermoplastic polymers, for example, acrylonitrile butadiene styrene, acrylic, celluloid, cellulose acetate, cyclic olefin copolymer, ethylene-vinyl acetate, ethylene vinyl alcohol, polytetrafluoro ethylene, ionomers, liquid crystal polymer, polyoxymethylene, polyacrylates, polyacrylonitrile, polyamide (e.g., polyamide 66 or polyamide 6), polyamide-imide, polyimide, polyaryletherketone, polybutadiene, polybutylene terephthalate, polycarpolactone, polychlorotrifluoroetyhlene, polyether ether ketone, polyethylene terephthalate, poly-cylcohexylene dimethylene terephthalate, polycarbonate, polyhydroxalkanoates, polyketones, polyester, polyolefin (e.g., polyethylene, polypropylene, polybutylene, and the like) polyetherketoneketone, polyetherimide, polyethersulfone, polysulfone, chlorinated polyethylene, polylactic acid, polymethylmetacrylate, polymethylpentene, polyphenylene, polyphenylene sulfide (PPS), polyphthalamide, polystyrene, polysulfone, polytrimethylene terephthalate, polyurethane, polyvinyl acetate, polyvinyl chloride, polyvinylidene chloride, styrene-acrylonitrile, or mixtures thereof. Polyamides and polyphenylene sulfides are particularly preferred.

The thermally conductive polymer suitable for SLS printing can contain a thermally conductive filler. In general, the total filler weight added to the polymer or combination of polymers is less than about 55 wt.%, less than about 50 wt.%, less than about 45 wt.%, less than about 40 wt.%, less than about 35 wt.%, less than about 30 wt.%, less than about 25 wt.%, less than about 20 wt.%, less than about 15 wt.%, less than about 10 wt.%, or less than about 5 wt.%. For example, the total filler weight can be from about 5 wt.% to about 55 wt.%, from about 10 wt.% to about 50 wt.%, from about 10 wt.% to about 45 wt.%, from about 10 wt.% to about 40 wt.%, from about 15 wt.% to about 40 wt.%, from about 20 wt.% to about 40 wt.%, from about 25 wt.% to about 40 wt.%, from about 30 wt.% to about 40 wt.%, or from about 35 wt.% to about 40 wt.%.

The thermally conductive filler can comprise any filler with thermal conductivity known in the art. The filler can have high thermal conductivity (for example, having a thermal conductivity of up to about 900 W/m/K or greater than about 10 W/m/K), an intermediate thermal conductivity (for example, having a thermal conductivity of from about 5 W/m/K to about 10 W/m/K), or a low thermal conductivity (less than about 5 W/m/K). Generally, high thermal conductivity and intermediate thermal conductivity fillers are preferred when used primarily as the thermally conductive filler.

As an example, the thermally conductive filler can comprise carbon black, alumina, boron nitride, silica, carbon fiber, graphene, graphene oxide, graphite (such as, for example, expanded graphite, synthesized graphite, low-temperature expanded graphite, and the like), aluminum nitride, silicon nitride, metal oxide (such as, for example, zinc oxide, magnesium oxide, beryllium oxide, titanium oxide, zirconium oxide, yttrium oxide, and the like), carbon nanotubes, calcium carbonate, talc, mica, wollastonite, clays (including exfoliated clays), metal powders (such as, for example, aluminum, copper, bronze, brass, and the like), or mixtures thereof.

In the thermally conductive polymers used for SLS printing of the present disclosure, the melting point of the polymers is at least about 25° C., for example, at least about 30° C., at least about 40° C., at least about 45° C., or at least about 50° C. For example, the melting point is from about 25° C. to about 50° C., from about 30° C. to about 50° C., from about 35° C. to about 50° C., or from about 40° C. to about 50° C.

The thermally conductive polymers may also have a crystallization point of at least about 25° C., for example, at least about 30° C., at least about 40° C., at least about 45° C., or at least about 50° C. For example, the crystallization point is from about 25° C. to about 50° C., from about 30° C. to about 50° C., from about 35° C. to about 50° C., or from about 40° C. to about 50° C.

As aforementioned, the optical properties of the thermally conductive polymers are also an important factor to consider to configure the thermally conductive polymer for SLS printing. For example, the thermally conductive polymers may have an optical density or absorbance at 10.6 μm of at least about 0.4, at least about 0.45, at least about 0.5, at least about 0.55, at least about 0.6, at least about 0.65, at least about 0.7, at least about 0.75, at least about 0.8, at least about 0.85, at least about 0.9, at least about 0.95, or at least about 1.0. For example, the absorbance at 10.6 μm is from about 0.4 to about 1, from about 0.4 to about 0.95, from about 0.45 to about 0.95, from about 0.45 to about 0.9, from about 0.5 to about 0.9, from about 0.5 to about 0.85, from about 0.55 to about 0.85, from about 0.55 to about 0.8, from about 0.6 to about 0.8, from about 0.6 to about 0.75, or from about 0.6 to about 0.7.

The thermally conductive polymers of the present disclosure may have a particle size of at least about 10 μm, at least about 15 μm, at least about 20 μm, at least about 25 μm, at least about 30 μm, at least about 35 μm, at least about 40 μm, at least about 45 μm, at least about 50 μm, at least about 55 μm, at least about 60 μm, at least about 65 μm, at least about 70 μm, at least about 75 μm, at least about 80 μm, at least about 85 μm, or at least about 90 μm. For example, the thermally conductive polymers have a particle size distribution of from about 10 μm to about 90 μm, from about 15 μm to about 90 μm, from about 15 μm to about 85 μm, from about 20 μm to about 85 μm, from about 20 μm to about 80 μm, from about 25 μm to about 80 μm, from about 25 μm to about 75 μm, from about 30 μm to about 70 μm, from about 35 μm to about 65 μm, from about 40 μm to about 60 μm, from about 10 μm to about 30 μm, from about 20 μm to about 40 μm, from about 30 μm to about 50 μm, from about 50 μm to about 70 μm, from about 60 μm to about 80 μm, or from about 70 μm to about 90 μm.

The flowability of the loose powder used in the SLS printing is also a factor to be considered when formulating the thermally conductive polymer. Flowability can be measured by the Hausner ratio. The Hausner ratio of the thermally conductive polymer powder is preferably less than about 1.25, for example, less than about 1.2, less than about 1.15, less than about 1.10, or less than about 1.05. For example, the Hausner ratio can be from about 1.19 to about 1.25, from about 1.12 to about 1.18, from about 1.12 to about 1.25, from about 1.00 to about 1.11, or from about 1.00 to about 1.25.

The thermally conductive polymers described herein are designed specifically for processes using sintering, sintering using lasers, or selective laser sintering. Thus, provided herein is a process of forming an article comprising: providing a thermally conductive polymer in the form of a loose powder; and sintering the loose powder in an SLS printing process to produce a 3D printed article. The sintering step typically takes place using a laser that solidifies the powder, as described above. Additional thermally conductive polymer in the form of a powder is provided typically using a recoating blade and the new powder is sintered. This process is repeated in “slices” until the entire desired article is formed.

The thermoplastic polymers and processes described herein can be used to prepare articles known to those skilled in the art. For example, the thermally conductive polymers used in the selective layer sintering of the present disclosure can be used in industries such as aerospace, automotive, and industrial to produce prototypes of testing and evaluation, providing a significantly lower cost compared to traditional manufacturing methods (e.g., extrusion and injection molding).

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and processes without departing from the scope of the invention, it is intended that all matter contained in the above description shall be interpreted as illustrative and not in a limiting sense.

1. A process of forming an article, the process comprising:
providing a thermally conductive polymer, wherein the polymer has a particle size distribution of from about 10 μm to about 90 μm and is in the form of a loose powder; and
sintering the loose powder in a sintering process to produce a 3D printed article comprising the thermally conductive polymer, wherein the sintering provides sufficient energy in order to solidify the powder.

2. The process of claim 1, wherein the thermally conductive polymer has a melting point of at least about 25° C.

3. The process of claim 1, wherein the thermally conductive polymer has an absorbance at 10.6 μm of at least about 0.4.

4. The process of claim 1, wherein the thermally conductive polymer has a Hausner ratio of less than about 1.25.

5. The process of claim 1, further comprising:
providing additional thermally conductive polymer material in the form of a loose powder on top of the sintered, solidified powder; and
sintering the loose powder of the additional thermally conductive polymer material, wherein the sintering provides sufficient energy in order to solidify the powder.

6. The process of claim 5, further comprising repeating the step of providing additional thermally conductive polymer material and sintering steps until the article is formed.

7. The process of claim 1, wherein the thermally conductive polymer has a melting point of from about 25° C. to about 50° C.

8. The process of claim 1, wherein the thermally conductive polymer has an absorbance at 10.6 μm of from about 0.4 to about 1.0.

9. The process claim 1, wherein the thermally conductive polymer has a particle size distribution of from about 20 μm to about 80 μm.

10. The process of claim 1, wherein the thermally conductive polymer has a Hausner ratio of from about 1.0 to about 1.25.

11. The process of claim 1, wherein the sintering step comprises sintering using lasers.

12. The process of claim 11, wherein the sintering step comprises selective laser sintering.

13. The process of claim 1, wherein the thermally conductive polymer comprises a polymer matrix comprising at least one polymer selected from the group consisting of polyphenylene sulfide, polyamide, polyketone, polyolefin, and mixtures thereof.

14. The process of claim 13, wherein the polyamide comprises polyamide 66, polyamide 6, or a mixture thereof.

15. The process of claim 1, wherein the thermally conductive polymer comprises a polymer matric and a thermally conductive filler in the polymer matrix.

16. A thermally conductive polymer comprising:
a polymer matrix; and
a thermally conductive filler in the polymer matrix;
wherein the polymer has a particle size distribution of from about 10 μm to about 90 μm and is in the form of a loose powder.

17. The polymer of claim 16, wherein the thermally conductive polymer has a melting point of at least about 25° C.

18. The polymer of claim 16, wherein the thermally conductive polymer has an absorbance at 10.6 μm of at least about 0.4.

19. The polymer of claim 16, wherein the thermally conductive polymer has a Hausner ratio of less than about 1.25.

20. The polymer of claim 16, wherein the polymer matrix comprises at least one polymer selected from the group consisting of polyphenylene sulfide, polyamide, polyketone, polyolefin, and mixtures thereof.
